(19) United States
(12) Patent Application Publication
(10) Pub. No.: US 2022/0134736 A1
(43) Pub. Date: May 5, 2022

(54) PRINT CONTROL INSTRUCTIONS

(71) Applicant: Hewlett-Packard Development Company, L.P., Spring, TX (US)

(72) Inventors: Josep Maria Cuner Utges, Sant Cugat del Valles (ES); Andreas Muller, Sant Cugat del Valles (ES); Mauricio Seras Franzoso, Sant Cugat del Valles (ES)

(73) Assignee: Hewlett-Packard Development Company, L.P., Spring, TX (US)

(21) Appl. No.: 17/419,358

(22) PCT Filed: Jul. 18, 2019
(86) PCT No.: PCT/US2019/042455

§ 371 Date: Jun. 29, 2021

(51) Int. Cl. B41J 2/045

(52) U.S. Cl. CPC B41J 2/04535; B41J 2/0458

(57) ABSTRACT

In an example, a machine-readable medium stores instructions which when executed by a processor cause the processor to determine a difference between a measured printed output and an expected printed output. Based on the difference, a first control instruction for controlling a drop size wherein the drop size is variable, and a second control instruction for controlling a dot density of a variable dot density may be determined.

### BACKGROUND

Printing systems can use printheads, such as thermal inkjet printheads or piezo based printheads, to eject a printing fluid, such as ink, onto a print media to form an image, Degradation of the printheads over time or part to part variation between printheads within a printing system can cause a reduction in printed image quality due to a printed color being different to the color intended to be printed. Therefore systems may be calibrated to improve image quality by improving color reproduction.

### BRIEF DESCRIPTION OF DRAWINGS

Non-limiting examples will now be described with reference to the accompanying drawings, in which:

FIG. 1 is a schematic drawing of an example machine-readable medium associated with a processor;

FIG. 2 is a schematic drawing of another example machine-readable medium associated with a processor;

FIG. 3 is an example of a calibration pattern according to one example;

FIG. 4A is an example method of calibrating a printing apparatus;

FIG. 4B is a graph illustrating a linearization table for calibrating a printing apparatus according to one example;

FIGS. 5A and 5B are graphs illustrating the relationship between ink drop size, ink dot density and lightness according to one example;

FIGS. 6 and 7 are flowcharts of example methods for use in calibrating a printing apparatus; and

FIG. 8 is a simplified schematic of an example of a printing apparatus.

### DETAILED DESCRIPTION

Print apparatus may perform calibrations based on a printed output—for example a calibration pattern—in order to maintain their color output throughout the life of the apparatus and to compensate differences between and within apparatus.

For example, calibration may be used in thermal inkjet (TIJ) based printing systems, as TIJ printheads may degrade over their life. Such printheads may use resistors to heat a printing fluid near a nozzle to cause a drop of printing fluid to be ejected from the nozzle, and degradation may for example be associated with the capability of the nozzle resistor to transmit the energy to an ink drop to be ejected being reduced through the printhead life, which can lead to lower drop weight over the lifetime and therefore less colorimetric output. Color variation can also occur because of factors such as printhead manufacturing differences, media properties and different environmental conditions. Drop weight degradation and drop weight differences between printheads can account for a significant part of the color variability of a printing system.

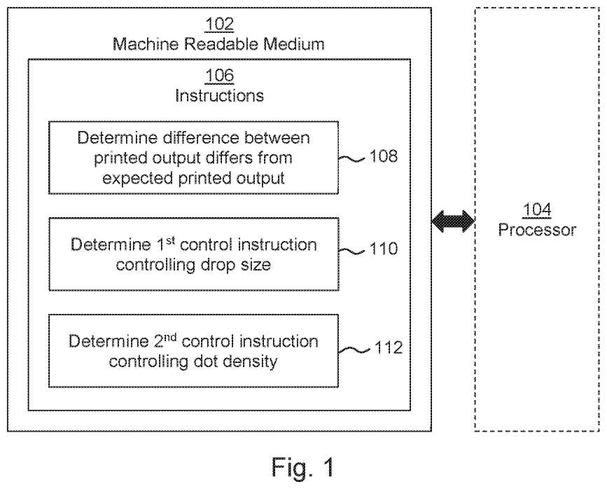

FIG. 1 shows an example of a machine-readable medium 102 associated with a processor 104. The machine-readable medium 102 stores instructions 106 which when executed by a processor 104 cause the processor 104 to carry out tasks. In this example, the instructions 106 comprise instructions 108 to cause the processor 104 to determine a difference between a measured printed output and an expected printed output. The measured aspect of the printed output may be a measure of the quantity of a printing fluid, such as ink, which is ejected from the printhead on to a print media, such as paper. The measurement may for example comprise measurement of a coverage value, which is the proportion of a region of the print media which is covered with printing fluid and may be expressed as a ratio or percentage of the region which is covered with printing fluid to the total area of the region (area covered with printing fluid plus the area not covered with printing fluid). A higher coverage value, or printed coverage, appears as a more saturated color, whereas a lower printed output results in a less saturated color and appears more similar in color to the print media. For example if black ink is printed by a printhead on white paper at 20%, the color of the printed region appears a light grey, at a higher coverage, such as 70%, the color of the printed region appears a darker grey and at 100% coverage the printed region appears black. Therefore, saturation may be measure of the quantity of a printing fluid which has been ejected.

The printed output may be assessed by measuring a value of colorimetric magnitude, wherein the colorimetric value may be a measure in L*, a*, b*, a measure of Chroma, a measure of optical density, or a combination thereof. The calorimetric magnitude may be a measure of light reflected by the media or may be a measure of such reflected light converted into a color space, for example L* a* b* or any other suitable color space. The measure of colorimetric values may generally provide a measure of saturation and/or printing fluid quantity.

The machine-readable medium 102 further comprises instructions 110 to determine, based on the difference, a first control instruction for controlling a drop size, wherein the drop size is variable. The machine-readable medium further comprises instructions 112 to determine, based on the difference, a second control instruction for controlling a dot density of a variable dot density.

In some examples controlling a drop size comprises modifying instructions which determine the energy delivered to a printhead when ejecting a printing fluid drop. Drop size, also referred to as drop weight or drop volume, may be controlled to vary the printed output. Drop size can be varied by adjusting the energy delivered to a printhead. In some examples, for example in piezo or TIJ based printheads, the drop size may be varied by applying a different voltage to the printhead to alter the energy delivered. In other examples, for example in a TIJ based printhead, the drop size can be varied by changing the duration of a voltage pulse applied to the printhead, which is also referred to as pulse width modulation. Therefore in some examples increasing or decreasing the energy is achieved by modifying control instructions to increase or decrease a time period for which a voltage is applied to a printhead, and determining the second control instructions may comprise determining a time period for which a voltage is applied. This may comprise modifying a previous or default time period.

There may be relatively little margin for modifying the drop size for TIJ printheads because increasing the energy delivered to the printhead causes additional heating which impacts printhead reliability as the increased temperature can cause ink to dry resulting in blocked nozzles. Also reducing the energy delivered can cause problems with drop formation because an under-energised drop may have more uncontrollable satellites and/or if the drop is too small it may fail to be ejected. Therefore varying the drop size may allow for relatively small variations when calibrating the printed output of a printhead.

Dot density refers to the number of dots of printing fluid printed on a print media per unit area. For example dot density may be measured in dots per inch (dpi) or dots per centimetre (dpcm) which is a count of the number of dots along a line of length one inch, or one centimetre respectively.

A printhead may move relative to a surface of a print media which is being printed on, for example the printhead may be mounted on a movable carriage or the print media may be moved by a print transport mechanism past the printhead. Therefore, the dot density can be controlled by varying the firing frequency of a printhead. In some examples instructions to modify the printing instructions to increase or decrease the printing fluid dot density comprise modifying the instructions to increase or decrease the rate at which ink drops are ejected from a printhead. For example if a printhead fires drops of ink at a higher rate, the print media will have more dots per unit area, whereas if the printhead fires drops of ink at a lower rate the print media will have fewer dots per unit area. Printheads may have an upper threshold rate at which they are capable of firing drops of printing fluid.

One example of a printing apparatus has a maximum sustained firing frequency in the range 9 kHz to 10 kHz to maintain reliability. If this threshold is surpassed the reliability of the printing apparatus may be reduced. In particular in printing apparatus which use inks with a relatively high ratio of pigments to fluid, referred to as high-particle inks, reliability can decrease when such a threshold is exceeded. Therefore there may be an upper threshold to the speed at which a printer can print while maintaining color saturation.

Determining the first control instruction may comprise setting or modifying an energy level to be supplied to a nozzle (for example by setting a pulse duration or voltage level) or in some examples determining that an existing energy level setting should be maintained. Determining the second control instruction may comprise setting or modifying a firing rate, or in some examples determining that an existing firing rate setting should be maintained. In some examples, the first and second control instructions may for example relate a color of printing fluid to an output drop size and dot density.

In other words, while both the dot density and the drop size may not be varied in every calibration operation, by providing for both the dot density and the drop size to be variable, as described in the method of FIG. 1, the maximum color saturation of a system may be increased compared to controlling either the dot density or the drop size alone. This may allow better color saturation and a wider gamut, which may be particularly useful at higher printing speeds, which can be associated with a reduction in maximum gamut/saturation. For example if the printed coverage is to be adjusted during calibration by 10%, then 4% change may be achieved by increasing the dot density and 6% change may be achieved by increasing the drop size. More generally, by controlling both the dot density and the drop size, the ‘calibration space’ is increased, and factors such as printhead longevity may be considered and/or balanced with achieving high color saturations and wide color gamuts.

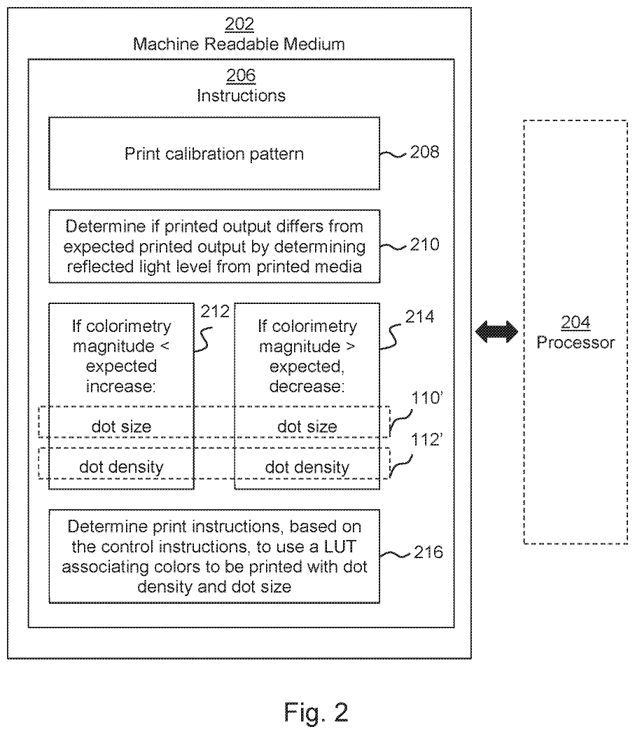

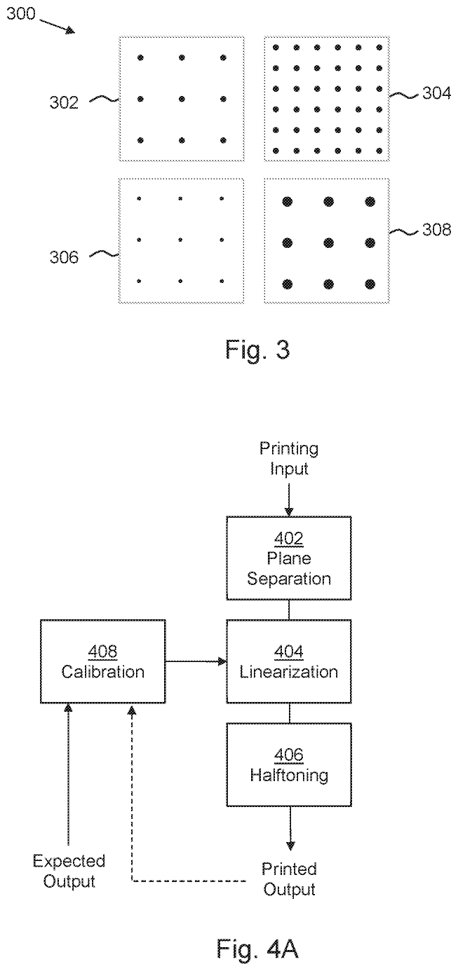

FIG. 2 shows an example of a machine-readable medium 202 associated with a processor 204. The machine-readable medium 202 stores instructions 206 which when executed by the processor 204 cause the processor to carry out tasks. In this example, the instructions 206 comprise instructions 208 to cause the processor 204 to cause a calibration pattern to be printed on a printable media. Examples of such a calibration pattern will be discussed further in relation to FIG. 3.

The instructions 206 further comprise instructions 210 to cause the processor 204 to determine if a measured colorimetric magnitude is greater than or less than an expected colorimetric magnitude by determining a light level reflected from a printed media. In some examples the printed output is a printed calibration pattern, for example as shown in FIG. 3. In other examples the printed output may be any image or pattern printed by a printing apparatus to be calibrated.

The instructions 206 further comprise instructions 212 and instructions 214, to cause the processor 204 to determine the control instructions. If the colorimetric magnitude of the measured printed output is less than the expected colorimetric magnitude (e.g. the saturation is lower than expected), instructions 212 determine control instructions to increase at least one of the dot density and the drop size compared to the control instructions used to print the measured printed output. If the colorimetric magnitude of the printed output is greater than the expected calorimetric magnitude (e.g. the saturation is greater than expected), instructions 214 determine control instructions to decrease at least one of the dot density and the drop size compared to the control instructions used to print the measured printed output.

Box 110′ corresponds to determining the first control instruction to control the drop size (i.e. instructions 110 of FIG. 1) and box 112′ corresponds to determining the second control instruction to control the drop size (i.e. instructions 112 of FIG. 1).

The instructions 206 further comprise instructions to cause the processor 204 to determine print instructions to print a subsequent print output based on the first and second control instructions. In this example the instructions 216 cause the processor 204 to determine print instructions comprise instructions to use a look up table (LUT) associating colors to be printed with a dot density and a drop size, wherein determining the first and second control instructions may comprise setting or modifying entries in the look up table. The LUT may associate values in a first color space with values in a second color space. For example the first color space may be the CIELAB color space which expresses a color as three values: L* for the lightness, a* from green to red and b* from blue to yellow. In other examples the first color space may be RGB in which a color is expressed in terms of red, green and blue. The second color space may be a color space which is suitable for use in printing, such as the CMYK color space wherein a color is expressed in terms of cyan, magenta, yellow and black.

In other examples, rather than modifying the LUT, the modifications may be applied as a correction. For example a table separate from the LUT may be generated which is used to modify the values of a static LUT i.e. a LUT which is not modified. In this way a default LUT may be maintained and the corrections applied to the default LUT as necessary. For example each entry in a static default LUT may be supplemented by a correction entry in a correction LUT, and two look-up operations may be performed to determine the print instructions.

Some printing apparatus comprise a plurality of printheads. Therefore in some examples the method of calibration may be performed for each printhead of the plurality of printheads in the printing apparatus. In this way each printhead can print colors consistently and variation between printheads may be reduced.

FIG. 3 is an example of a calibration pattern 300, for example as printed according to the instructions 208. The calibration pattern 300 comprises a first region 302 comprising dots at a first dot density, a second region 304 comprising dots at a second dot density, a third region 306 comprising dots at a first size, a fourth region 308 comprising dots at a second size. In this example the second dot density is greater than the first dot density and the second size is greater than the first size. While the dots shown in the Figures are relatively distantly spaced for clarity, these may be closer together in some examples.

This calibration pattern 300 provides regions with two different dot densities and two different dot sizes. In some examples the dot density of the first region 302 may be the same as the dot density of either the third region 306 or the fourth region 308. In other examples the dot density of the second region may be the same as the dot density of either the third region 306 or the fourth region 308.

A printing apparatus may print the calibration pattern 300 by varying the drop size to print different sized dots and by varying dot density between the different regions 302-308, wherein the drop size and dot density are controlled in print instructions. After printing the calibration pattern, the printing apparatus may perform a measurement on the printed calibration pattern. For example the printing apparatus may comprise a sensor which may be used to measure the regions 302-308 of the calibration pattern 300. In some examples the sensor may be a spectrophotometer or a photodiode and light source, and/or may be provided as part of an ‘in-line’ scanner apparatus past which the printed media is passed. In other examples, the sensor may be separate from a print apparatus. The sensor may measure the quantity or the color of light reflected from each region of the calibration pattern 300. In some examples, a calibration pattern 300 may be printed for each printing fluid of the print apparatus (for example, a calibration pattern may be printed in each of a Cyan, Magenta, Yellow and blacK ink of a CMYK printer, and/or the first and second control instructions may be determined each printing separately).

Such a pattern may be measured by a print apparatus and used in a calibration procedure. In some examples, it may be assumed that there is a substantially linear relationship between the dot density and the visual lightness or darkness of the printed color and that there is also a substantially linear relationship between the dot size and the visual lightness or darkness of the printed color. In other examples a more complex interpolation may be used to determine how control instructions should be set such that the printed output tends towards an intended printed output. In some examples, calibration patterns may be printed based on new control instructions (e.g. a different dot and/or dot density) until a printed output which meets predetermined parameters is produced.

While in this example, there are two different dot sizes and two different dot densities, in other examples more regions with different dot sizes and dot densities may be printed and measured.

In some examples measuring the magnitude of light reflected comprises measuring light reflected from each of the first region 302, the second region 304, the third region 306 and the fourth region 308. The printing apparatus may then compare the measured magnitude of light returned from each region to an expected value. In one example the printing apparatus may then select the region which had a measured reflected light closest to the expected value and use the drop size and dot density parameters which were used in printing that particular region when printing that particular color in future printing operations. In other examples the printing apparatus may perform an interpolation to determine the dot density and drop size which should be used when printing a particular color based on the measured printed calibration pattern 300.

In a particular example the printing apparatus may be calibrated by printing a calibration pattern with three different dot sizes by printing three regions: a first region comprising dots printed by applying a high energy to the printhead, a second region comprising dots printed by applying a nominal energy to the printhead and a third region comprising dots printed by applying a low energy to the printhead (where high and low are defined relative to the upper and lower energy thresholds for firing a nozzle in a given printing system). In one example the calibration pattern is printed using pulse width modulation by applying a voltage to the printhead for around 444 nanoseconds (ns) to print the first region, by applying a voltage to the printhead for around 489 ns to print the second region and applying a voltage to the printhead for around 556 ns to print the third region. The applied voltage to the resistor of a TIJ printhead may be in the range of 27 volts (V) to 32V DC. In some examples a voltage of 30V is supplied to the printhead.

The three regions may be scanned using an optical sensor. The printing apparatus may then determine which of the three regions is closest to an expected printed output based on the measurements of the optical sensor. The printing apparatus may then set an operating energy point for the printheads by setting the pulse width based on this determination. The printing apparatus may then further calibrate the printed output by controlling dot density. The printed calibration pattern further comprises regions of different dot density which are measured and compared to generate a measured dot density versus lightness relationship. The measured dot density versus lightness relationship is then compared with an expected dot density versus lightness relationship. The printing apparatus then determines a new dot density to obtain the same density output as the expected dot density using the dot density versus lightness relationship.

In other words, a first stage of calibration may be to determine the energy to be supplied to a printhead, setting in effect the nominal dot size for calibrated print operations by selecting one of the printed dot sizes, and a second stage of calibration may be to specify how dot density relates to saturation, given the selected dot size, such that intended saturation(s) may be achieved in further printed outputs.

Although in some examples two regions may be used as set out above, by providing a third region (or indeed more than three regions) additional checks may be made. For example the trend that an increase in energy and therefore drop size equates to an increased saturation can be checked over at least two differential points. In contrast if just two regions are printed, then one differential check, and therefore one data point is provided which may result in a less robust calibration.

The second region may printed with a pulse duration substantially at the expected nominal pulse width. The first region and the third region may be printed with pulse widths lower and higher than the nominal pulse width respectively. This means that the actual nominal pulse width is likely to be included within the range between these higher and lower pulse widths. In other examples, this may be applied to voltage levels, and/or further regions may provide additional energy levels, which may have greater distances from the nominal energy levels, or may provide intermediate energy levels.

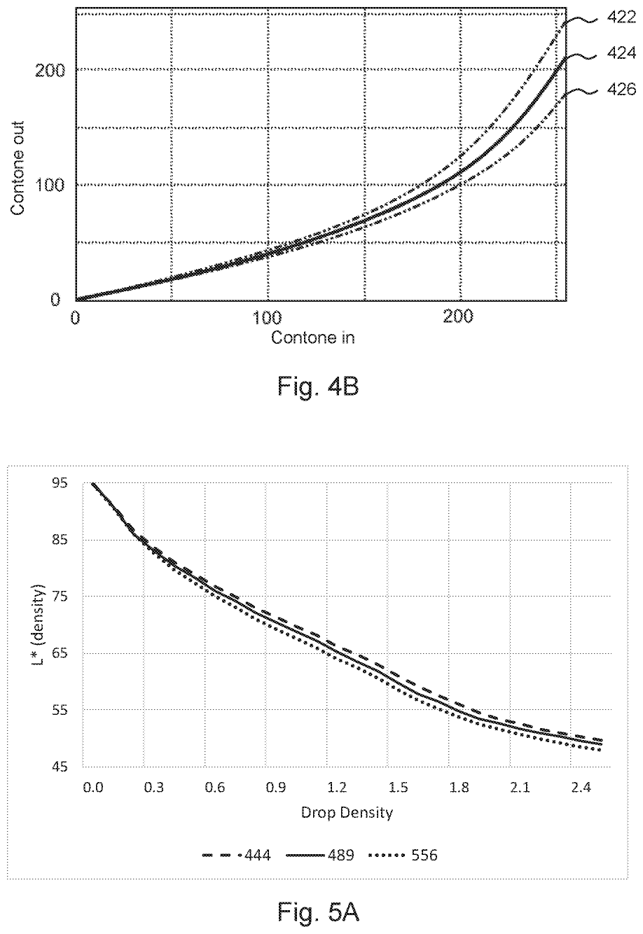

FIG. 4A shows an example flowchart of a method which may be used to print a printed output by a printing apparatus. In block 402, the printing input is received, wherein the printing input is an image to be printed (wherein the term image as used herein includes text and patterns, and wherein the image may be provided as or in data file or the like), and the input is separated into planes. For example, the planes may correspond to colors of ink available in the printing apparatus, for example cyan, yellow, magenta and black. In block 404, linearization is performed on the separated planes, for example using a linearization table such as that described with reference to FIG. 4B below. Linearization modifies the contone values of the input plane based on the contents of the linearization table, as further set out below.

In block 406, halftoning is performed on the planes to determine where to place ink dots when printing the image. A calibration may be performed using the printed output in block 408, by measuring the printed output as described above and comparing the printed output to an expected output. The calibration in this example comprises, if and when appropriate based on the measurements, modifying the linearization tables (for example directly, or but determining a correction to be applied to a result of a lookup operation), such that when subsequent planes are processed the printed output will more closely resemble the expected printed output, thereby improving color reproduction of the printing apparatus.

The linearization table may comprise a look up table (LUT) and an example of values from such a table is shown in FIG. 4B which shows curves used to convert an input contone value to an output contone value. Curves are shown for a range of dot count ratios (DCR), wherein DCR refers to a number to be multiplied by the nominal dot density in order to achieve an expected printed output. Line 424 corresponds to a DCR of 1.00, line 422 corresponds to a DCR of 0.85 and line 426 corresponds to a DCR of 1.15. It can be seen that for a given input contone, the output contone is increased relative to the nominal state of a DCR of 1.00 for a lower DCR of 0.85, whereas the output contone is decreased relative to the nominal state of a DCR of 1.00 for a higher DCR of 1.15.

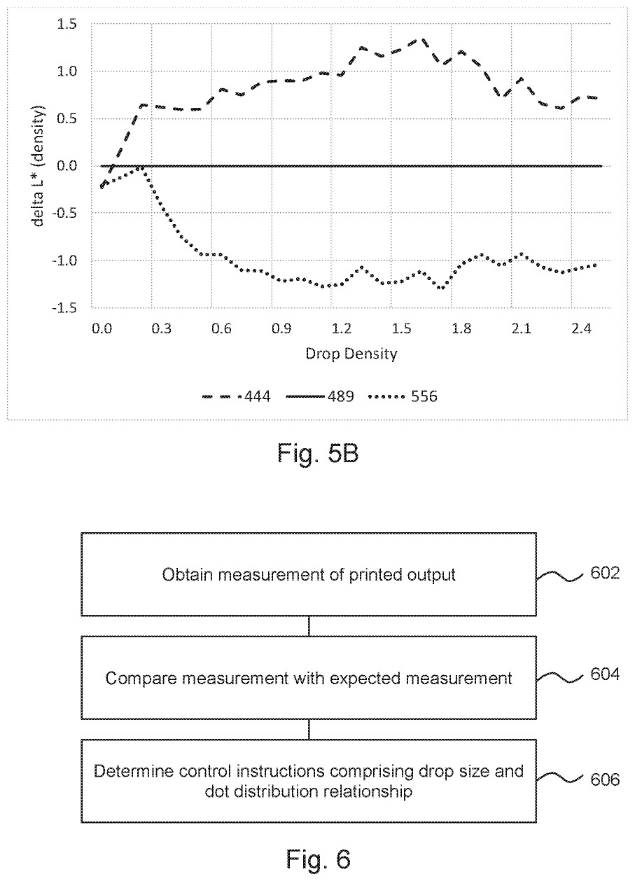

FIGS. 5A and 5B show how the measured lightness varies with dot density for different dot sizes of cyan ink. The three lines in the graphs correspond to different sized dots printed using pulse width modulation by applying a voltage to the printhead for, in this example, 444 ns, 489 ns and 556 ns. The horizontal axis of FIGS. 5A and 5B represent drop density expressed in terms of DCR, i.e. relative to a nominal density. FIG. 5A shows the absolute measured lightness, whereas FIG. 5B shows the difference in measured lightness for 444 ns and 556 ns relative to the measured lightness at 489 ns. As can be seen from the figures, the lightness decreases as drop density increases and the measured lightness is higher for smaller drops. The measured lightness may correspond to (the dimensionless quantity) L* of the CIELAB color space.

As can be seen in FIG. 5B, at the maximum modelled drop density in the example system of 2.5, there is a difference of +0.7 delta L* when 556 ns is used compared with when 489 ns is used and a difference of −1.1 delta L* when 444 ns is used compared with when 489 ns is used. In this example, at the maximum firing frequency, the densities are L* 47.9 at 556ns, L* 49.0 at 489ns and L* 49.7 at 444 ns. Therefore by using a pulse width of 556 ns rather than 489 ns, the nominal (i.e. 489 ns) maximum density of 49.0 can be achieved at a lower dot density of 2.35. Therefore by operating at a higher pulse width, and therefore energy, the rate at which the printhead fires can be reduced and still achieve the same lightness, potentially reducing impact on printhead lifespan. Additionally the achievable printed output density may be increased by operating at both a high drop density and a high energy.

FIG. 6 shows an example of a method, which may be a method of calibrating a printing apparatus. In this example block 602 comprises obtaining a measurement of a printed output on a print media.

Block 604 comprises comparing the measurement of the printed output with an expected measurement to determine if the measured printed output differs from an expected printed output.

Block 606 comprises determining, based on the comparison, control instructions which describe or control a relationship between a drop size and a dot distribution by setting a variable drop size and a variable dot distribution. The variable dot distribution may be variable in terms of dot density wherein dot density characterises how close (for example on average, along a unit length) dots are to one another.

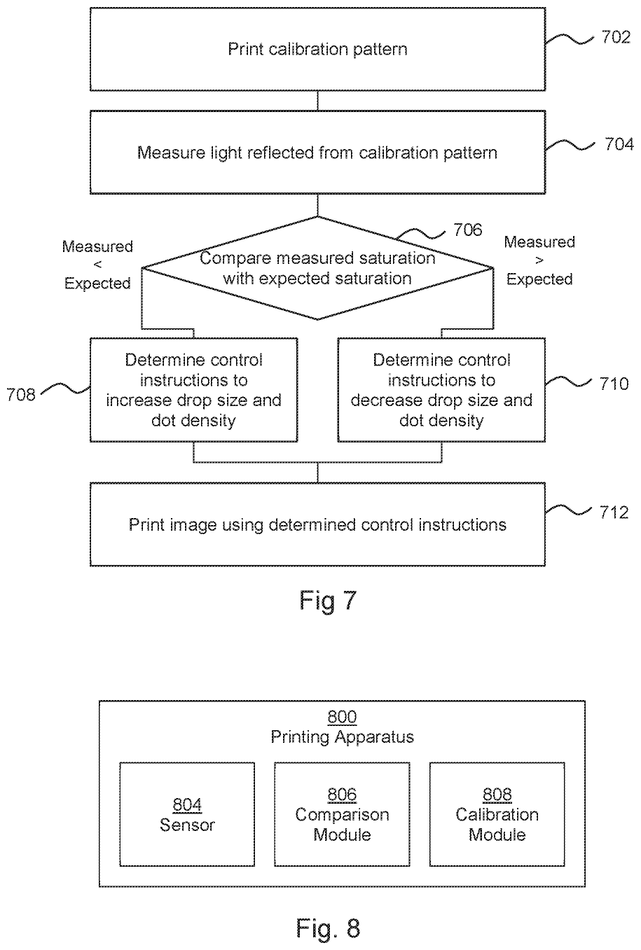

FIG. 7 shows an example of a method, which may be a method of calibrating a printing apparatus. In this example block 702 comprises printing a calibration pattern on the print media.

Block 704 comprises measuring light reflected from the printed calibration pattern.

In this example, obtaining the measurement of the printed output comprises determining a value indicative of color saturation, and block 706 comprises comparing the measured color saturation with the expected color saturation. If the measured color saturation is less than the expected color saturation, in block 708 the control instructions are determined to increase the drop size and increase the dot density.

If the measured color saturation is greater than the expected color saturation, in block 710 control instructions are determined to decrease the drop size and decrease the dot density.

Block 712 comprises printing an image using the determined control instructions.

In some examples, when printing an image, a printhead of a printing apparatus will pass over the same region of a print media being printed on a number of times. For example in different print modes the printhead may pass over a region six times, eight times or ten times. These print modes may be referred to as six pass, eight pass and ten pass respectively. In print modes with a lower number of passes, the image can be printed more quickly, however the image quality may be lower and/or the printheads may fire at a higher rate. In a thermal ink jet (TIJ) printer, the printheads may have a maximum firing rate, which may be in the range of around 9 KHz to 10 kHz in some example systems. If the printer were to operate above this maximum firing rate reliability may be reduced so many printers do not operate above their maximum firing rate. Therefore, when printing using print modes with fewer passes this maximum firing rate may be reached resulting in printed images comprising colors of reduced saturation than intended, as the firing rate is effectively capped at the maximum value.

In some examples printing the image comprises passing a printhead over a point on the media a number of times, and wherein the size of dots printed by the printhead is increased and the rate of firing drops of ink from the printhead are increased when the number of passes is decreased. In this way, the saturation of the printed image may be maintained, even when operating in a print mode with a low number of passes, without surpassing maximum firing rates.

In some examples, the dot density and the drop size may be set for each print pass mode.

FIG. 8 shows an example of a printing apparatus 800. The printing apparatus 800 comprises a sensor 804 to measure a printed output and a comparison module 806 (which may comprise part of processing circuitry of the printing apparatus 800) to compare the measured printed output with an expected output. The printing apparatus 800 further comprises a calibration module 808 (which may comprise part of processing circuitry of the printing apparatus 800) to determine if a measured printed output differs from an expected output. Based on the difference the calibration module 808 further determines a first control instruction for controlling a drop size, wherein the drop size is variable and a second control instruction for controlling a dot density of a variable dot density. For example, determining the control instructions may comprise setting or varying a value in a look-up table as described above, or leaving such a value unchanged. In some examples the printing apparatus is a thermal ink jet printer. In some examples the method described herein may be used by printing apparatus which uses a pipeline such as a HANS pipeline (a Neugebauer Primary based color separation and halftoning print control approach).

The printing apparatus (or processing circuitry thereof) may for example perform any of the blocks of FIG. 4A, 6 or 7, and/or may execute machine-readable instructions as described in relation to FIG. 1 or FIG. 2.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (for example, any or any combination of the comparison module 806 and the calibration module 808) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A machine-readable medium storing instructions which when executed by a processor cause the processor to:
determine a difference between a measured printed output and an expected printed output;
determine, based on the difference:
(i) a first control instruction for controlling a drop size, wherein the drop size is variable; and
(ii) a second control instruction for controlling a dot density of a variable dot density.

2. A machine-readable medium according to claim 1 further comprising instructions to:
print a calibration pattern on a printable media to provide the printed output to be measured.

3. A machine-readable medium as claimed in claim 1, wherein the determined instructions to determine the difference between a measured printed output and an expected printed output comprise instructions to determine a light level reflected from a printed media.

4. A machine-readable medium as claimed in claim 1, wherein determined difference is a difference between an expected colorimetric magnitude and a measured colorimetric magnitude and the instructions to determine the first and second control instructions comprise:
instructions to, if the colorimetric magnitude of the measured printed output is less than the expected colorimetric magnitude, determine control instructions to increase at least one of the dot density and the drop size compared to the control instructions used to print the measured printed output; and
instructions to, if the colorimetric magnitude of the measured printed output is greater than the expected colorimetric magnitude, determine control instructions to decrease at least one of the dot density and the drop size compared to the control instructions used to print the measured printed output.

5. A machine-readable medium according to claim 1 further comprising instructions to:
determine print instructions to print a subsequent print output based on the first and second control instructions.

6. A machine-readable medium as claimed in claim 5, wherein
the instructions to determine the print instructions comprise instructions to use a look up table associating colors to be printed with a dot density and a drop size,
wherein determining the first and second control instructions comprises setting and/or modifying entries in the look up table.

7. A machine-readable medium as claimed in claim 6, further comprising instructions to:
cause a calibration pattern to be printed on a printable media to provide the printed output, wherein the calibration pattern comprises:
a first region comprising dots at a first dot density;
a second region comprising dots at a second dot density;
a third region comprising dots at a first size;
a fourth region comprising dots at a second size, wherein
the second dot density is greater than the first dot density; and
the second size is greater than the first size.

8. A machine-readable medium as claimed in claim 7, further comprising instructions to measure a magnitude of light reflected from each of the first region, the second region, the third region and the fourth region to determine the difference between the measured printed output and the expected printed output.

9. A method comprising:
obtaining a measurement of a printed output on a print media;
comparing the measurement of the printed output with an expected measurement to determine if the measured printed output differs from an expected printed output; and
determining, based on the comparison, control instructions describing a drop size and a dot distribution relationship by setting a variable drop size and a variable dot distribution.

10. A method according to claim 9, wherein obtaining the measurement of the printed output comprises determining a value indicative of color saturation, and
if the color saturation of the printed output is less than an expected color saturation, determining the control instructions so as to increase the drop size and increase a dot density of dot distribution; and
if the color saturation of the printed output is greater than the expected color saturation, determining the control instructions so as to decrease the drop size and decrease the dot density.

11. A method according to claim 9 further comprising:
printing a calibration pattern on the print media, and
measuring light reflected from the printed calibration pattern to obtain the measurement of the printed output.

12. A method according to claim 9, further comprising:
printing an image using the determined control instructions.

13. A method according to claim 12, wherein printing the image comprises passing a printhead over a point on the print media in a number of passes, and wherein a size of dots printed by the printhead is increased and a rate of firing drops of ink from the printhead are increased when the number of passes is decreased.

14. A printing apparatus comprising:
a sensor to measure a printed output:
a comparison module to compare the measured printed output with an expected output;
a calibration module to determine a difference between a measured printed output and an expected output and determine, based on the difference:
(i) a first control instruction for controlling a drop size, wherein the drop size is variable; and
(ii) a second control instruction for controlling a dot density of a variable dot density.

15. A printing apparatus according to claim 14 wherein the printing apparatus is a thermal ink jet printer.
